(19) United States
(12) Patent Application Publication
(10) Pub. No.: US 2012/0188483 A1
(43) Pub. Date: Jul. 26, 2012

(54) DISPLAY SYSTEM AND BACKLIGHT SYSTEM

(75) Inventors: Katsuro Matsuzaki, Kanagawa (JP); Kensuke Motomura, Kanagawa (JP)

(73) Assignee: SONY CORPORATION, Tokyo (JP)

(21) Appl. No.: 13/351,532

(22) Filed: Jan. 17, 2012

(30) Foreign Application Priority Data
Jan. 26, 2011 (JP) P2011-013655

(51) Int. Cl. G02F 1/13357; H05B 37/02

(52) U.S. Cl. 349/62; 315/158

(57) ABSTRACT

A display system includes: a liquid crystal display section displaying an image; a backlight source emitting source light; a photosensor section detecting a spectrum distribution of external light supplied from outside; and an external-light adjustment section adjusting the external light based on a detection result of the photosensor section. The backlight source supplies the emitted source light to the liquid crystal display section, and the external-light adjustment section supplies the adjusted external light to the liquid crystal display section.

### CROSS-REFERENCE TO RELATED APPLICATION

The present application claims priority from Japanese Patent Application No. JP 2011-013655 filed in the Japanese Patent Office on Jan. 26, 2011, the entire content of which is incorporated herein by reference.

### BACKGROUND

The disclosure relates to a display system which displays an image by utilizing external light, and a backlight system used in the display system.

In recent years, a transition progresses in display devices from CRTs (Cathode-Ray Tubes) to thin display devices such as liquid crystal display devices. In particular, the liquid crystal display devices are capable of achieving low power consumption, and are thus becoming a mainstream of thin display devices from the viewpoint of ecology as well.

Some of the display devices utilize external light such as sunlight. For example, Japanese Unexamined Patent Application Publication Nos. H09-179119, H11-95215, and 2002-311412 propose a liquid crystal display device and a backlight system, in which external light is introduced from a back face thereof to thereby reduce power consumption especially when they are used outside.

### SUMMARY

There are some cases where external light may turn out to be undesirable as a light source of a backlight. For example, a color of the external light varies depending on time. The color of the external light becomes a color approximate to white in the daytime or becomes reddish in the evening, for example. The external light is influenced by the weather as well. Further, in downtown at night or the like, the color of the external light is far from white. Thus, when the color of the external light becomes greatly different from white, a color displayed on a display device becomes different from a desired color as well, which may consequently cause degradation of image quality. Japanese Unexamined Patent Application Publication Nos. H09-179119, H11-95215, and 2002-311412, however, are all silent with regard to a color of external light.

It is desirable to provide a display system and a backlight system, which are capable of suppressing degradation of image quality even when, in utilizing external light, a color of the external light is varied.

A display system according to an embodiment of the technology includes a liquid crystal display section displaying an image; a backlight source emitting source light; a photosensor section detecting a spectrum distribution of external light supplied from outside; and an external-light adjustment section adjusting the external light based on a detection result of the photosensor section. The backlight source supplies the emitted source light to the liquid crystal display section, and the external-light adjustment section supplies the adjusted external light to the liquid crystal display section.

A backlight system according to an embodiment of the technology includes a backlight source emitting source light; a photosensor section detecting a spectrum distribution of external light supplied from outside; and an external-light adjustment section adjusting the external light based on a detection result of the photosensor section. The backlight source supplies the emitted source light to a liquid crystal display section, and the external-light adjustment section supplies the adjusted external light to the liquid crystal display section.

In the display system and the backlight system according to the embodiments of the technology, the external light supplied from the outside and the source light emitted from the backlight source are supplied as backlight to the liquid crystal display section to perform displaying. The external light is adjusted based on the spectrum distribution of the external light detected by the photosensor section, and is supplied to the liquid crystal display section thereafter.

Advantageously, the external-light adjustment section adjusts a light intensity of the external light to be reduced when the spectrum distribution of the external light is out of a predetermined range.

Advantageously, the external-light adjustment section performs a spectrum conversion of the spectrum distribution of the external light into a spectrum distribution which is more approximate to white.

Advantageously, the external-light adjustment section performs the spectrum conversion when the spectrum distribution of the external light is within a predetermined range.

Advantageously, the predetermined range is preselected by a user.

Advantageously, a light source control section controlling the backlight source based on the detection result of the photosensor section may be further included.

Advantageously, the backlight source includes a red-light source, a green-light source, and a blue-light source, and the light source control section controls a light intensity of each of the red-light source, the green-light source, and the blue-light source independently, based on the detection result of the photosensor section.

Advantageously, the photosensor section detects a light intensity of the external light, and the light source control section controls the light intensity of the source light to be higher when the light intensity of the external light is lower than a predetermined light intensity.

Advantageously, a display control section controlling the liquid crystal display section may be further included, and the liquid crystal display section includes a red pixel, a green pixel, and a blue pixel, and the display control section controls pixel displaying of each of the red pixel, the green pixel, and the blue pixel independently, based on the detection result of the photosensor section.

Advantageously, the photosensor section detects a light intensity of the external light, and the external-light adjustment section adjusts the light intensity of the external light to be reduced when the light intensity of the external light is higher than a predetermined light intensity.

Advantageously, a light condensing section condensing the light may be further provided, and the external light is supplied from the light condensing section via an optical fiber.

Advantageously, the external light is directly supplied from a back face of the liquid crystal display section.

Advantageously, the external light is sunlight.

Advantageously, a plurality of operation modes including an image display mode and an illumination mode may be further included, and the liquid crystal display section displays the image in the image display mode, and the liquid crystal display section stays in a transparent state in the illumination mode.

Advantageously, the liquid crystal display section displays a ratio of the light intensity between the source light and the external light which are supplied to the liquid crystal display section.

Advantageously, an ambient light sensor section detecting light around the display system may be further provided.

Advantageously, the backlight includes a half mirror allowing light incident on a first face thereof to exit from a second face thereof, and allowing light incident from the second face to be reflected.

According to the display system and the backlight system of the embodiments of the technology, the external light used as backlight is adjusted based on the spectrum distribution of the external light. Therefore, it is possible to reduce degradation of image quality.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram depicting an example of a configuration of a display system according to a first embodiment of the technology.

FIG. 2 is a block diagram depicting an example of a configuration of an external-light control section shown in FIG. 1.

FIG. 3A to FIG. 3C each are a view illustrating an example of a spectrum distribution recorded in a database shown in FIG. 2.

FIG. 4 is a view illustrating an example of a setting screen of the display system shown in FIG. 1.

FIG. 5 is a structural view illustrating an example of a configuration of a backlight shown in FIG. 1.

FIG. 6 is a block diagram depicting an example of a configuration of a display control section and a liquid crystal display section shown in FIG. 1.

FIG. 7 is a circuit diagram illustrating an example of a configuration of a pixel shown in FIG. 6.

FIG. 8 is a flowchart illustrating an example of an operation of the display system shown in FIG. 1.

FIG. 9 is a view illustrating an example of a display screen of the display system shown in FIG. 1.

FIG. 10 is a structural view illustrating an example of a configuration of a backlight according to a modification of the first embodiment.

FIG. 11 is a block diagram depicting an example of a configuration of an external-light control section according to a second embodiment of the technology.

FIG. 12 is a flowchart illustrating an example of an operation of a display system shown in FIG. 11.

FIG. 13 is a block diagram depicting an example of a configuration of a display system according to a modification of the second embodiment.

FIG. 14 is a block diagram depicting an example of a configuration of an external-light control section shown in FIG. 13.

FIG. 15 is a structural view illustrating an example of a configuration of a backlight according to another modification of the second embodiment.

FIG. 16 is a block diagram depicting an example of a configuration of a display system according to yet another modification of the second embodiment.

FIG. 17 is a block diagram depicting an example of a configuration of an external-light control section shown in FIG. 16.

FIG. 18 is a block diagram depicting an example of a configuration of a display system according to a third embodiment of the technology.

FIG. 19 is a structural view illustrating an example of a configuration of an external-light control section and a backlight shown in FIG. 18.

FIG. 20 is a view illustrating an example of a display screen of a display system according to a modification.

### DETAILED DESCRIPTION

Hereinafter, embodiments of the technology will be described in detail with reference to the drawings. The description will be given in the following sequential order.

1. First Embodiment

2. Second Embodiment

3. Third Embodiment

### 1. First Embodiment

### [Example of Configuration]

### [Example of Entire Configuration]

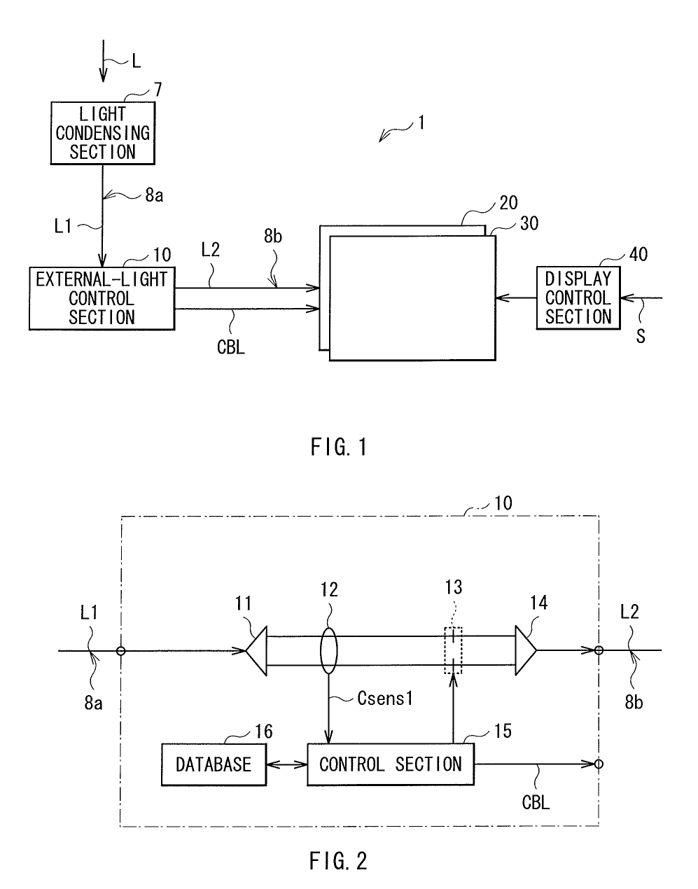

FIG. 1 illustrates an example of a configuration of a display system according to a first embodiment of the technology. A display system 1 is a display system which uses, as backlight, external light as well as light emitted from a light source (source light). The display system 1 may be applied to a television image receiver, for example. It is to be noted that a backlight system according to an embodiment of the technology is also described collectively herein, since the backlight system is embodied by the present embodiment. The display system 1 includes a light condensing section 7, an external-light control section 10, a backlight 20, a display control section 40, and a liquid crystal display section 30.

The light condensing section 7 serves to condense external light L. The light condensing section 7 can be such as a light-condensing dome installed on a building roof for condensing sunlight, for example. The external light L condensed by the light condensing section 7 is supplied as light L1 to the external-light control section 10 via an optical fiber 8a. The external-light control section 10 detects a light intensity (such as luminance and intensity of illumination, for example) and a spectrum distribution (spectrum) of the light L1, and adjusts the light intensity of the external light based on a detection result thereof. The external light whose light intensity is adjusted in the external-light control section 10 is supplied as light L2 to the backlight 20 via an optical fiber 8b. The backlight 20 supplies light to the liquid crystal display section 30. More specifically, the backlight 20 supplies the external light (for example, the light L2) supplied from the external-light control section 10 as well as the source light emitted from a light source 22 (to be described later) to the liquid crystal display section 30. The liquid crystal display section 30 serves to display an image, and is configured of a liquid crystal display element as a display element.

### [External-Light Control Section 10]

FIG. 2 illustrates an example of a configuration of the external-light control section 10. The external-light control section 10 has a scattering lens 11, a photosensor section 12, a light-intensity adjustment section 13, a light condensing lens 14, a database 16, and a control section 15.

The scattering lens 11 is a lens which serves to increase a diameter of a luminous flux of the light L1 supplied via the optical fiber 8a. The scattering lens 11 increases the diameter of the light L1, thereby enabling the photosensor section 12 and the light-intensity adjustment section 13 to easily perform processes on that luminous flux.

The photosensor section 12 detects the light intensity and the spectrum distribution of the light supplied from the scattering lens 11. The photosensor section 12 can be such as a photodiode and a CCD (Charge Coupled Device) image sensor, for example. The photosensor section 12 supplies a detection result thereof to the control section 15 as a detection signal Csens1.

The light-intensity adjustment section 13 adjusts, based on instructions from the control section 15, an intensity of the light supplied from the scattering lens 11 via the photosensor section 12. The light-intensity adjustment section 13 can be such as an aperture stop mechanism used for light quantity adjustment, such as that employed in a digital camera, for example.

The light condensing lens 14 is a lens which serves to condense a luminous flux supplied from the light-intensity adjustment section 13. The light condensed by the light condensing lens 14 is supplied as light L2 to the backlight 20 via the optical fiber 8b.

The database 16 is a database in which spectrum distributions of various types of external light are recorded therein. More specifically, the database 16 has information on such as a spectrum distribution of sunlight in various conditions and a spectrum distribution of various light sources (such as but not limited to a fluorescent lamp and an electric bulb).

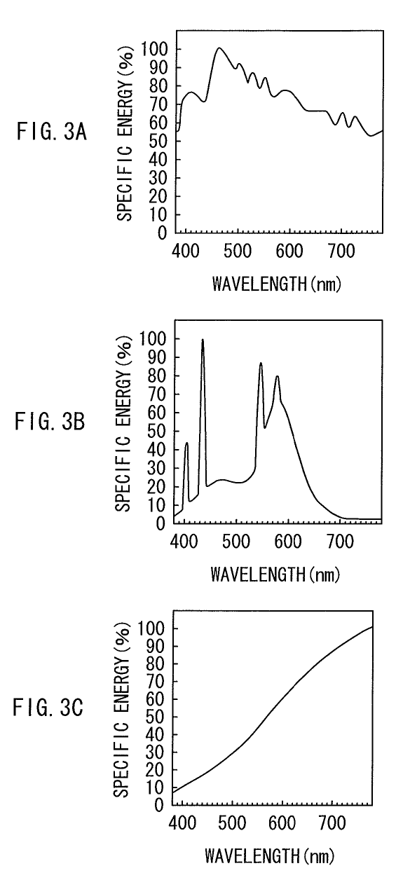

FIGS. 3A to 3C each illustrate an example of the information on the spectrum distribution included in the database 16. FIG. 3A shows a spectrum distribution of sunlight in the daytime, FIG. 3B shows a spectrum distribution of a fluorescent lamp, and FIG. 3C shows a spectrum distribution of an electric bulb. In this embodiment, the database 16 may have, other than those described previously, a spectrum distribution of sunlight at various times such as in the morning and in the evening, and/or a spectrum distribution of sunlight in various weather conditions such as cloudy and rainy. The database 16 may have information on further various types of spectrum distributions for the spectrum distribution of the fluorescent lamp and the electric bulb, for example. More specifically, for the spectrum distribution of the electric bulb, the database 16 may have the information on the spectrum distribution of a plurality of electric bulbs such as, but not limited to, a tungsten electric bulb and a halogen electric bulb.

The database 16 may be so configured as to add and update the spectrum distribution of new types of external light, such as by means of a user input, a self-learning function, and downloading from an unillustrated external network.

The control section 15, based on the detection signal Csens1, controls the light-intensity adjustment section 13 and controls a light intensity of the source light in the light source 22 (to be described later) of the backlight 20. As will be described later in detail, the control section 15 compares the detection result derived from the photosensor section 12 to data recorded in the database 16 to perform analysis based on the detection result, to thereby identify a type of the external light L. For example, when a spectrum distribution of the external light L coincides (or substantially coincides) with that of the sunlight in the daytime recorded in the database 16 in a predetermined allowable margin, the control section 15 determines that the type of the external light L is the sunlight in the daytime. Also, for example, when a spectrum distribution of the external light L coincides (or substantially coincides) with that of the tungsten electric bulb recorded in the database 16 in a predetermined allowable margin, the control section 15 determines that the type of the external light L is the light of the electric bulb. Then, the control section 15 compares the thus-identified type of the external light L with types of external light described in an external light source list ‘List’ (to be described later) to thereby control the light source control section 21 (to be described later).

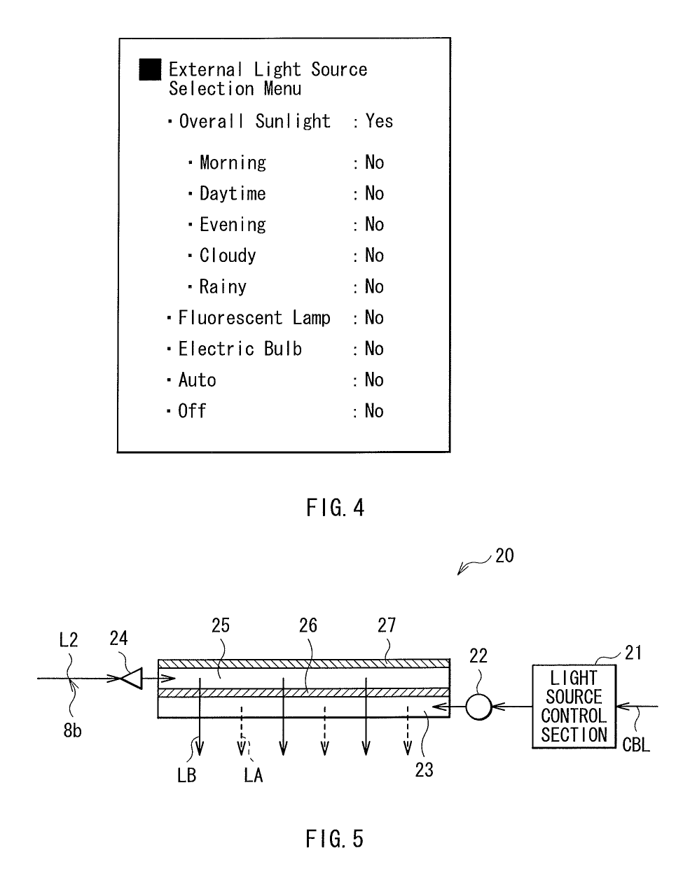

FIG. 4 illustrates an example of a screen for setting a type of the external light L. This user interface sets a type of the external light to be used as backlight. In this embodiment, when using the sunlight, the fluorescent lamp, and the electric bulb as the external light L, respective items of “Overall Sunlight”, “Fluorescent Lamp”, and “Electric Bulb” are set to “Yes”. When using the sunlight in each time of morning, daytime, and evening, respective items of “Morning”, “Daytime”, and “Evening” are set to “Yes”. When using the sunlight in each weather condition of cloudy and rainy, respective items of “Cloudy” and “Rainy” are set to “Yes”. Also, when allowing the display system 1 to select a type of the external light to be used as backlight, an item of “Auto” is set to “Yes”. Further, when any external light is not to be used as backlight, an item of “Off” is set to “Yes”. Thus, the type of the external light L set by a user to “Yes” is stored in the control section 15 as the external light source list ‘List’.

The display system 1, when the external light coinciding with the type of the external light L set by a user (i.e., coinciding with the external light source list ‘List’) is supplied thereto, that external light L is used as backlight. Namely, the display system 1 provides a system in which the external light usable as backlight is selectable by a user. More specifically, when a type of the external light L identified based on the detection result derived from the photosensor section 12 is described in the external light source list ‘List’, the control section 15 determines that the external light L is allowed to be used as backlight. In this case, the control section 15 so controls the light-intensity adjustment section 13 that the light-intensity adjustment section 13 allows to pass the light therethrough as much as possible. Also, the control section 15 may so control the light source control section 21 as to weaken the light intensity of the source light of the light source 22 (to be described later), when the intensity of the light having passed through the light-intensity adjustment section 13 is sufficient as backlight to be supplied to the liquid crystal display section 30, for example. On the other hand, when the identified type of the external light L is not described in the external light source list ‘List’, the control section 15 determines that the external light L is undesirable to be used as backlight. In this case, the control section 15 so controls the light-intensity adjustment section 13 as to weaken the light intensity of the external light (the light L2) and so controls the light source control section 21 as to strengthen the light intensity of the source light of the light source 22. Thereby, the display system 1 makes it possible to supply backlight having sufficient light intensity to the liquid crystal display section 30.

### [Backlight 20]

FIG. 5 illustrates an example of a configuration of the backlight 20. The backlight 20 has the light source 22, the light source control section 21, a light guide plate 23, a scattering plate 24, a light guide plate 25, a half mirror 26, and a reflection plate 27.

The light source 22 allows light to exit therefrom. In this embodiment, the light source 22 is configured such as by a CCFL (Cold Cathode Fluorescent Lamp). The light source control section 21 controls an intensity of the light exited from the light source 22, based on a backlight control signal CBL. The light guide plate 23 so guides the light exited from the light source 22 that the light spreads throughout the whole area thereof, and functions to supply the light substantially uniformly to a display region of the liquid crystal display section 30. It is to be noted that while, in this embodiment, the light source 22 is configured by the CCFL, it is not limited thereto. Alternatively, the light source 22 may be configured such as by LEDs (Light Emitting Diodes), for example.

The scattering plate 24 scatters the external light (the light L2) supplied from the external-light control section 10 via the optical fiber 8b, in order to allow the external light to be incident on the light guide plate 25. The light guide plate 25 so guides the light supplied from the scattering plate 24 that the light spreads throughout the whole area thereof. The half mirror 26 allows the light incident on one face thereof to pass therethrough, and allows the light incident on the other face thereof to be reflected therefrom. The half mirror 26 is provided between the light guide plate 23 and the light guide plate 25, and allows the light entering from the light guide plate 25 to pass therethrough, and allows the light entering from the light guide plate 23 to be reflected therefrom. The reflection plate 27 reflects the light incident thereon. The reflection plate 27 is provided on a face of the light guide plate 25 opposite to (opposed to) a face on which the half mirror 26 is provided, and allows the light entering from the light guide plate 25 to be reflected therefrom.

With this configuration, in the backlight 20, the source light exited from the light source 22 spreads by the light guide plate 23 throughout the whole area thereof, and the light is reflected from the half mirror 26 to be exited as light LA toward (for example, in a downward direction of FIG. 5) the unillustrated liquid crystal display section 30. Also, the external light (the light L2) supplied from the external-light control section 10 spreads by the light guide plate 25 throughout the whole area thereof, and the light is reflected from the reflection plate 27 to be exited as light LB toward the unillustrated liquid crystal display section 30 via the half mirror 26 and the light guide plate 23. Here, the light which enters the half mirror 26 from the light guide plate 23 is reflected by the half mirror 26. Thus, for example, a loss of light caused by a leakage toward the external-light control section 10 via the light guide plates 23 and 25 and the scattering plate 24 of the source light exited from the light source 22 is less likely to occur.

### [Display Control Section 40 and Liquid Crystal Display Section 30]

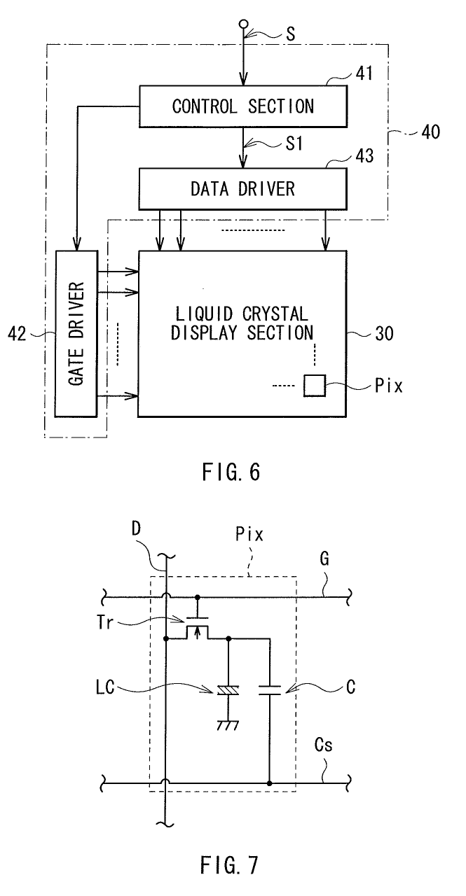

FIG. 6 illustrates an example of a block diagram of the display control section 40 and the liquid crystal display section 30. The display control section 40 includes a control section 41, a gate driver 42, and a data driver 43. The control section 41 controls a drive timing of the gate driver and the data driver 43, and supplies a supplied image signal S to the data driver 43 as an image signal S1. The gate driver 42 sequentially selects pixels Pix in the liquid crystal display section 30 for each row in accordance with timing control by the control section 41 to perform line-sequential scanning. The data driver 43 supplies a pixel signal that is based on the image signal S to each of the pixels Pix of the liquid crystal display section 30.

The liquid crystal display section 30 has a configuration in which a liquid crystal material is sealed between two transparent substrates made of such as glass, for example. At a portion facing the liquid crystal material of each of these transparent substrates, a transparent electrode made of such as ITO (Indium Tin Oxide), for example, is formed, and constitutes the pixels Pix together with the liquid crystal material. As illustrated in FIG. 6, the pixels Pix are disposed in matrix in the liquid crystal display section 30.

FIG. 7 illustrates an example of a circuit diagram of the pixel Pix. The pixel Pix includes a TFT (Thin-Film Transistor) element Tr, a liquid crystal element LC, and a holding capacitor element C. The TFT element Tr may be configured by a MOS-FET (Metal Oxide Semiconductor-Field Effect Transistor), for example, in which a gate is connected to a gate line G, a source is connected to a data line D, and a drain is connected to a first end of the liquid crystal element LC and a first end of the holding capacitor element C. The liquid crystal element LC has the first end connected to the drain of the TFT element Tr, and a second end which is grounded. The holding capacitor element C has the first end connected to the drain of the TFT element Tr, and a second end connected to a holding capacitor line Cs. The gate line G is connected to the gate driver 42, and the data line D is connected to the data driver 43.

With this configuration, the light LA and the light LB exited from the backlight 20 each become a linear polarization in a direction defined by a polarization plate (not shown) disposed on the incident side of the liquid crystal display section 30, which are then incident on the liquid crystal element LC. In the liquid crystal element LC, an orientation of liquid crystal molecules varies in accordance with the pixel signal supplied via the data line D. The light thus incident on the liquid crystal element LC varies in its polarization direction. The light having passed through the liquid crystal element LC then enters a polarization plate (not shown) disposed on the emission side of the liquid crystal display section 30, where only the light in a specific polarization direction passes through. Thus, a modulation of the light intensity is performed in the liquid crystal element LC.

The photosensor section 12 corresponds to a specific (but not limitative) example of an “photosensor section” in one embodiment of the technology. The light-intensity adjustment section 13 corresponds to a specific (but not limitative) example of an “external-light adjustment section” in one embodiment of the technology. The light source 22 corresponds to a specific (but not limitative) example of a “backlight source” in one embodiment of the technology. Also, the spectrum distribution of the type of the external light L described in the external light source list ‘List’ and its allowable margin correspond to a specific (but not limitative) example of a “predetermined range” in one embodiment of the technology.

### [Operation and Effects]

An operation and effects of the display system 1 according to the present embodiment will now be described.

### [Outline of Overall Operation]

First, an outline of an overall operation of the display system 1 is described with reference to FIG. 1. The light condensing section 7 condenses the external light L. The external-light control section 10 detects the light intensity (such as the luminance and the intensity of illumination, for example) and the spectrum distribution (the spectrum) of the light L1 supplied from the light condensing section 7. Also, the external-light control section 10, based on the detection result thereof, adjusts the light intensity of the light L1 and outputs it as the light L2, and controls the light intensity of the source light which the light source 22 of the backlight 20 emits. The backlight 20 supplies the source light exited from the light source 22 and the external light (the light L2) supplied from the external-light control section 10 to the liquid crystal display section 30 as the light LA and the light LB, respectively. The display control section 40 controls the liquid crystal display section 30, based on the supplied image signal S. The liquid crystal display section 30 displays an image.

### [Detailed Operation]

Next, a detailed operation of the display system 1 will be described.

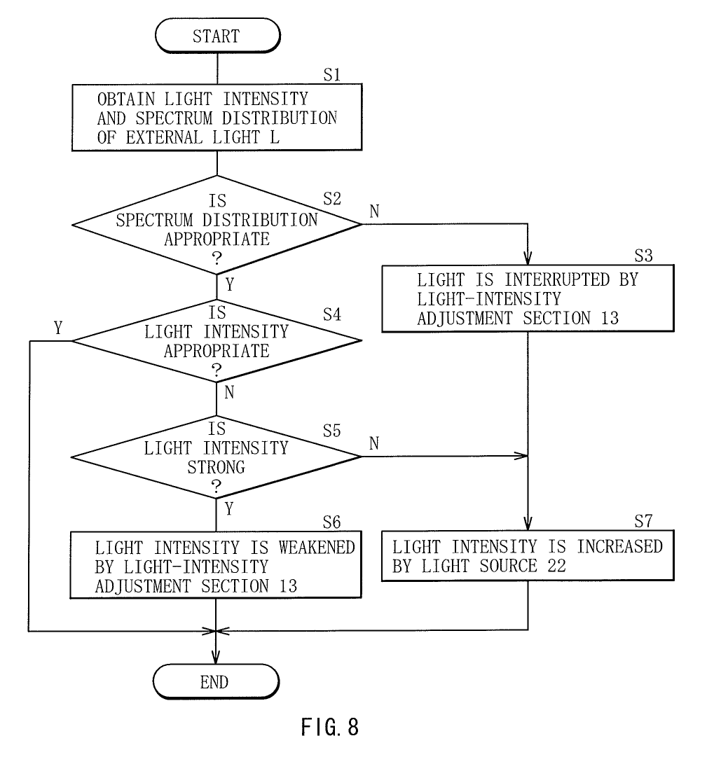

FIG. 8 illustrates a flowchart showing an example of an operation of the display system 1. The display system 1 adjusts, based on the light intensity and the spectrum distribution of the external light L, the light intensities of the light LA and the light LB that the backlight 20 supplies to the liquid crystal display section 30, which will be described in the following in detail.

First, the external-light control section 10 obtains the light intensity and the spectrum distribution of the external light L (step S1). More specifically, the photosensor section 12 of the external-light control section 10 detects the light intensity and the spectrum distribution of the light supplied from the scattering lens 11, to thereby obtain the light intensity and the spectrum distribution of the external light L. The photosensor section 12 then supplies the detection result thereof to the control section 15 as the detection signal Csens1.

Then, the control section 15 determines whether or not the spectrum distribution of the external light is appropriate (step S2). More specifically, the control section performs, based on the spectrum distribution of the external light L obtained in the step S1, the searching of the data in the database 16, the comparing, and the analyzing, to thereby identify the type of the external light L. Then, the control section 15 verifies whether or not the identified type of the external light L is described in the external light source list ‘List’, to thereby confirm whether or not the spectrum distribution of the external light L is appropriate for the spectrum distribution of backlight. When the identified type of the external light L is described in the external light source list ‘List’, the control section 15 determines that the spectrum distribution of the external light L is appropriate. In this case, the flow proceeds to step S4. On the other hand, when the identified type of the external light L is not described in the external light source list ‘List’, the control section 15 determines that the spectrum distribution of the external light L is not appropriate. In this case, the flow proceeds to step S3.

When the control section 15 has determined that the spectrum distribution of the external light L is not appropriate in the step S2, the light-intensity adjustment section 13 interrupts, based on the instructions from the control section 15, the light (step S3). Thereby, the light intensity of the light L2 that the external-light control section 10 supplies to the backlight 20 is lowered, and the light intensity of the light LB (the external light) that the backlight 20 supplies to the liquid crystal display section 30 is lowered. Thereafter, the flow proceeds to step S7.

When the control section 15 has determined that the spectrum distribution of the external light L is appropriate in the step S2, the control section 15 determines whether or not the light intensity of the external light L is appropriate (step S4). More specifically, the control section 15 confirms, based on the light intensity of the external light L obtained in the step S1, whether or not that light intensity is appropriate as the light intensity of backlight. When it is possible for the backlight 20 to sufficiently supply the light to the liquid crystal display section 30 only by the external light without allowing the light source 22 to emit light, the control section 15 determines that the light intensity is appropriate. In this case, the flow completes. On the other hand, when the light intensity is strong or when the light intensity is weak and thus the source light from the light source 22 is necessary, the control section 15 determines that the light intensity is not appropriate. In this case, the flow proceeds to step S5.

Next, the control section 15 determines whether or not the light intensity of the external light L is strong (step S5). More specifically, the control section 15 confirms, based on the light intensity of the external light L obtained in the step S1, whether or not the light intensity is strong. When the backlight 20 supplies the light excessively to the liquid crystal display section 30 despite the sole use of the external light L, the control section 15 determines that the light intensity is strong. In this case, the flow proceeds to step S6. On the other hand, when the sufficient supply of the light from the backlight 20 to the liquid crystal display section 30 is not possible by the external light L solely, the control section 15 determines that the light intensity is weak. In this case, the flow proceeds to step S7.

When the control section 15 has determined that the light intensity is strong in the step S5, the light-intensity adjustment section 13 weakens the light intensity of the incident light (step S6). The backlight 20 thereby supplies to the liquid crystal display section 30 only the external light supplied from the external-light control section 10. That is, in this case, the display system 1 uses only the external light as backlight.

When the control section 15 has determined that the light intensity is weak in the step S5 or when the light-intensity adjustment section 13 has interrupted the light in the step S3, the light source 22 of the backlight 20 increases the light intensity of the source light (step S7). More specifically, the light source control section 21 of the backlight 20 so controls, based on the backlight control signal CBL supplied from the control section 15 of the external-light control section 10, the light source 22 as to increase the light intensity of the source light which the light source 22 emits. Thus, when the control section 15 has determined in the step S5 that the light intensity of the external light is weak, the backlight 20 supplies the source light exited from the light source 22 as well as the external light supplied from the external-light control section 10 to the liquid crystal display section 30 as the light LA and the light LB, respectively. That is, in this case, the display system 1 uses both the external light and the source light as backlight. On the other hand, when the light-intensity adjustment section 13 has interrupted the light in the step S3, the backlight 20 supplies only the source light exited from the light source 22 to the liquid crystal display section as the external light LA. That is, in this case, the display system 1 uses only the source light of the light source 22 as backlight.

This completes the flow. The display system 1 carries out the flow at a frequency of 60 times to 240 times per second, for example. Thus, the backlight 20 is capable of supplying the light having the appropriate light intensity and the spectrum distribution to the liquid crystal display section 30 on a constant basis.

Next, effects of the display system 1 in one embodiment where the sunlight is used as the external light L will be described.

The sunlight has a continuous spectrum distribution in a wavelength range of visible light as shown in FIG. 3A. Namely, the sunlight is more ideal for a light source of a backlight as compared with a typical light source used for a backlight (such as a CCFL and an LED) in which spectra distribute discretely. Hence, a display device using the sunlight as backlight is capable of achieving a wide color gamut.

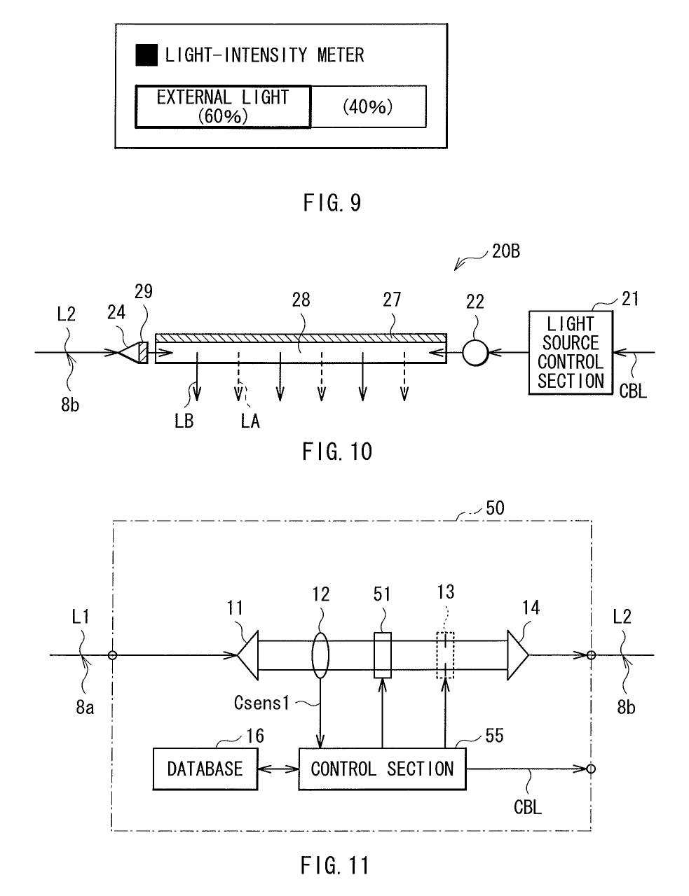

In addition, the sunlight can ensure a stable light intensity for a long period of time in the daytime. Hence, in addition to the light source 22, using the sunlight for the light source of the backlight in combination therewith makes it possible to suppress an intensity of emission of the light source 22 and to reduce power consumption. Also, a load imposed on the light source 22 is alleviated, thus making it possible to extend service life of the light source 22. Further, the display system 1 guides, as the light, the sunlight to the backlight 20. Hence, for example, as compared with a case where light is converted into electricity and the thus-converted electricity is supplied as power to a display system as in solar batteries, an efficiency is improved due to having no conversion loss, thus making it possible to reduce the power consumption. The use of the sunlight is thus effective from the viewpoint of ecology. Moreover, as shown in FIG. 9, a ratio between a light component of the light source 22 (the light LA) and a component of the external light L (the light LB) in the backlight 20 may be displayed on a screen to thereby allow a user to have enhanced interest in ecology.

Also, when the sunlight is used, a spectrum of indoor light (ambient light) and that of the light of the backlight become the same or substantially identical to each other especially in the daytime, making it possible to eliminate a necessity of adjusting white balance. This makes it possible to reduce a processing load in the display system.

### [Advantageous Results]

According to one embodiment of the technology described above, the light intensity and the spectrum distribution of the external light are detected, and use of that external light is controlled based on the detection result. Hence, even when the external light has a spectrum which is undesirable as backlight, it is possible to reduce an influence on backlight, and to increase image quality.

Also, in one embodiment of the technology described above, the external light is used as backlight, thus making it possible to reduce power consumption of the display system and to extend service life of such as the light source. In particular, using the sunlight for the external light makes it possible to achieve a wide color gamut and to increase the image quality.

### [Modification 1-1]

In one embodiment described above, the spectrum distributions of various types of external light are stored in the database 16, although it is not limited thereto. Alternatively, a factor such as color temperature, chromaticity, and a color-rendering property of various types of external light may be stored therein. In the following, one embodiment (modification 1-1) where the color temperature is stored will be described.

An example of an operation (flowchart) of a display system according to this modification is substantially the same as that of the display system 1 according to the embodiment described above (FIG. 8). First, the photosensor section 12 obtains the light intensity and the spectrum distribution of the external light L (step S1). Then, the control section 15 obtains, based on the spectrum distribution of the external light L obtained in the step S1, the color temperature. The control section 15 performs, based on the thus-obtained color temperature, the searching of the data in the database 16, the comparing, and the analyzing, to thereby identify the type of the external light L. Then, as in the embodiment described above, the control section 15 verifies whether or not the identified type of the external light L is described in the external light source list ‘List’, to thereby confirm whether or not the spectrum distribution of the external light L is appropriate for the spectrum distribution of backlight (step S2). The operation subsequent thereto is same as that of the embodiment described above.

In this modification, the photosensor section 12 obtains the spectrum distribution of the external light L, and the control section 15 obtains the color temperature based on that spectrum distribution, although it is not limited thereto. For example, the photosensor section 12 may directly obtain the color temperature of the external light L.

### [Modification 1-2]

In one embodiment described above, the external-light control section 10 detects the light intensity, although it is not limited thereto. For example, in one embodiment (modification 1-2), the light intensity may be integrated by a predetermined time to detect it as a light quantity, instead of the light intensity.

### [Modification 1-3]

In one embodiment described above, the two light guide plates 23 and 25 are used to configure the backlight 20, although it is not limited thereto. Alternatively, the backlight may be configured by a single light guide plate, one embodiment (modification 1-3) of which will be described hereinafter in detail.

FIG. 10 illustrates an example of a configuration of a backlight 20B according to this modification. The backlight 20B has a light guide plate 28 and a half mirror 29. The light guide plate 28 so guides the external light supplied from the scattering plate 24 and the source light exited from the light source 22 as to spread throughout the whole area thereof. The half mirror 29 is provided between the scattering plate 24 and the light guide plate 28, and allows the light entering from the scattering plate 24 to pass therethrough, and allows the light entering from the light guide plate 28 to be reflected therefrom.

With this configuration, in the backlight 20, the source light exited from the light source 22 spreads by the light guide plate 28 throughout the whole area thereof, and the light is reflected from the reflection plate 27 to be exited as the light LA toward (for example, in a downward direction of FIG. 10) the unillustrated liquid crystal display section 30. Also, the external light (the light L2) supplied from the external-light control section 10 spreads by the same light guide plate 28 throughout the whole area thereof, and the light is reflected from the reflection plate 27 to be exited as the light LB toward (for example, in the downward direction of FIG. 10) the unillustrated liquid crystal display section 30. Here, the light which enters the half mirror 29 from the light guide plate 28 is reflected by the half mirror 29. Thus, for example, a loss of light is less likely to occur.

### 2. Second Embodiment

A display system 2 according to a second embodiment of the technology will now be described. In the present embodiment, a spectrum distribution of backlight is also so adjusted, based on the spectrum distribution of the external light L, as to be approximate to a spectrum distribution ideal for backlight, for example. That is, in the present embodiment, an external-light control section 50 having a function of converting, based on the spectrum distribution of the external light L, a spectrum distribution of light is used to configure the display system 2. Note that the same or equivalent elements as those of the display system 1 according to the first embodiment described above are denoted with the same reference numerals, and will not be described in detail.

FIG. 11 illustrates an example of a configuration of the external-light control section 50 according to the present embodiment. The external-light control section 50 has, in addition to the function of the external-light control section according to the first embodiment, a function of converting, based on the spectrum distribution of the external light, a spectrum distribution of light. The external-light control section 50 has a spectrum conversion section 51 and a control section 55.

The spectrum conversion section 51 converts, based on instructions from the control section 55, a spectrum distribution of incident light to other spectrum distribution to output the same.

A phenomenon is referred to as luminescence in which excitation is generated by reception of energy such as light and heat followed by releasing of the received energy as light. The luminescence includes fluorescence and phosphorescence. It is generally known as the Stokes' law that, when a fluorescent substance is irradiated by light to generate the luminescence, light with its wavelength longer than that of the light irradiated is re-radiated, for example. That is, a spectrum conversion is possible by utilizing a fluorescent substance.

In one embodiment, the spectrum conversion section 51 may be configured to radiate the external light onto the fluorescent substance to perform the spectrum conversion in accordance with the low described previously, for example. In an alternative embodiment, the spectrum conversion section 51 may be configured to attenuate each specific wavelength separately by using such as color filters to adjust the spectrum distribution.

The control section 55, based on the detection signal Csens1, controls the light-intensity adjustment section 13 to control the light intensity of the source light exited from the light source 22 of the backlight 20, and controls the spectrum conversion section 51. As described later, the control section 55 performs, based on the detection result derived from the photosensor 12, the searching of the data in the database 16 to thereby identify the type of the external light L. Then, the control section 55 controls, based on the type of the external light L, the spectrum conversion section 51. The spectrum conversion section 51 may perform the spectrum conversion (a wavelength conversion) of the spectrum distribution of the incident light to convert the same into a spectrum distribution ideal for backlight, and may output the light subjected to the spectrum conversion, for example. The spectrum distribution ideal for backlight can be such as the spectrum distribution of the sunlight in the daytime and a spectrum distribution of white, although it is not limited thereto.

The light-intensity adjustment section 13 and the spectrum conversion section 51 correspond to a specific (but not limitative) example of the “external-light adjustment section” in one embodiment of the technology.

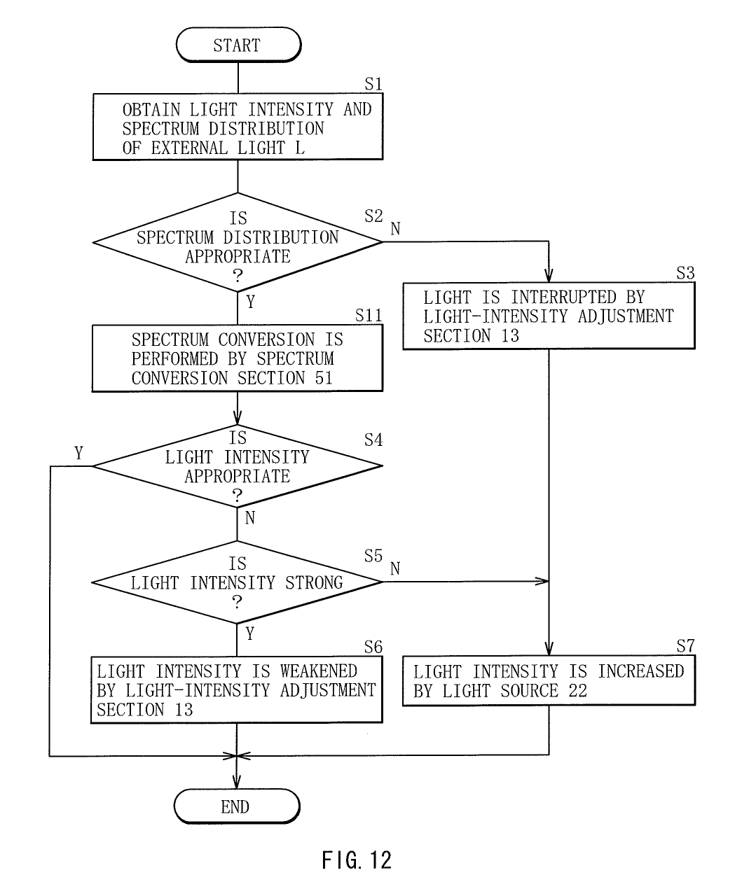

FIG. 12 is a flowchart illustrating an example of an operation of the display system 2. This flowchart has step S11 between the step S2 and the step S4 in the display system 1 according to the first embodiment described above (FIG. 8). The step S11 is a process step in which, based on the type of the external light L, the conversion of a spectrum is performed.

In the step S11, the spectrum conversion section 51 performs the spectrum conversion. More specifically, the control section 55 controls, based on the type of the external light L identified in the step S2, the spectrum conversion section 51. Then, the spectrum conversion section 51 performs, based on the instructions from the control section 55, the spectrum conversion of, for example, the spectrum distribution of the incident light to convert the same into the spectrum distribution ideal for backlight, and outputs the light subjected to the spectrum conversion.

Thus, in the display system 2, even when the external light is not white light, the spectrum conversion section 51 converts the spectrum distribution thereof. Thereby, it is possible to achieve backlight having the ideal spectrum distribution, and to achieve adjustment of white balance.

In one embodiment where a plural types of fluorescent substances are used to configure the spectrum conversion section 51, a configuration may be employed in which the fluorescent substances to be subjected to the external light are changed in accordance with the instructions from the control section 55, by which the spectrum conversion of the spectrum distribution of the external light is performed selectively to convert the same into the plurality of mutually-different spectrum distributions selectively. Thus, even when a spectrum of the external light varies depending on the time such as in the morning, in the daytime, and in the evening in case the sunlight is used for the external light, it is possible to reduce an influence of the variation in the external light on backlight. Also, in one embodiment, ultraviolet-rays may be used as the external light and the ultraviolet-rays may be converted into a wavelength of a visible light bandwidth, to effectively utilize the external light.

According to the second embodiment, the spectrum conversion section performs the spectrum conversion, based on the spectrum distribution of the external light. Thus, even when the external light is not the white light, the spectrum conversion is so performed as to approximate backlight to the spectrum distribution which is approximate to the more ideal white light. Hence, it is possible to reduce an influence on backlight, and to increase image quality. Other advantageous results achieved by the second embodiment are similar to those according to the first embodiment described above.

### [Modification 2-1]

In the second embodiment described above, the spectrum conversion section 51 performs the spectrum conversion based on the spectrum distribution of the external light, although it is not limited thereto. For example, a photosensor section which detects a spectrum distribution of light (ambient light) around the display system may be further provided, to thereby perform the spectrum conversion based on the spectrum distributions of the external light and the ambient light, one embodiment (modification 2-1) of which will be described hereinafter in detail.

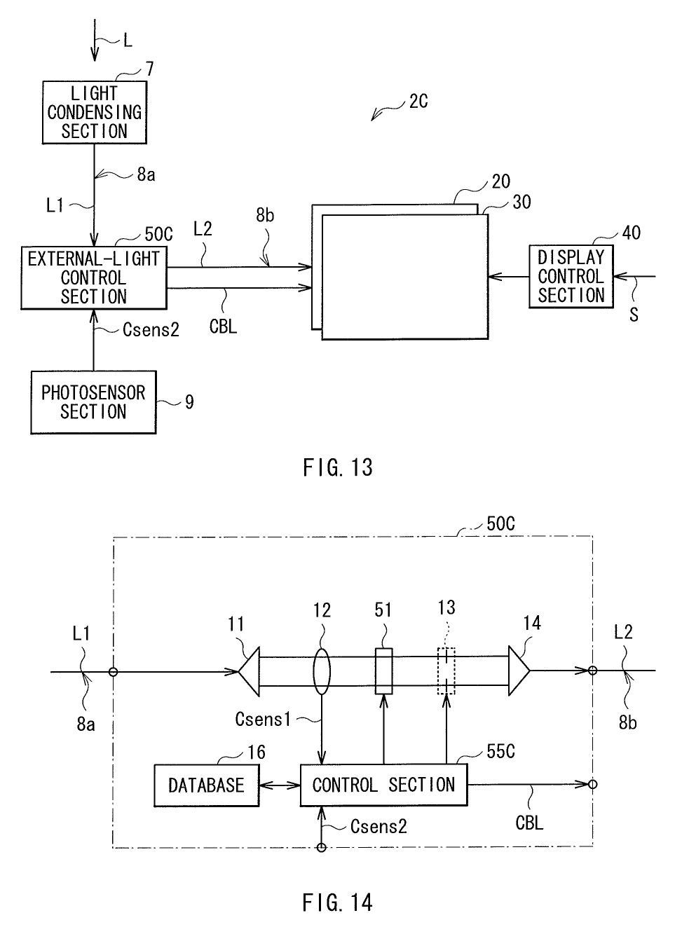

FIG. 13 illustrates an example of a configuration of a display system 2C according to the present modification. The display system 2C is provided with a photosensor section 9 and an external-light control section 50C. The photosensor section 9 detects a spectrum distribution of the light (the ambient light) around the display system 2C, and supplies a detection result thereof to the external-light control section 50C as a detection signal Csens2. The photosensor section 9 corresponds to a specific (but not limitative) example of an “ambient light sensor section” in one embodiment of the technology.

FIG. 14 illustrates an example of a configuration of the external-light control section 50C. The external-light control section 50C has a control section 55C. The control section 55C has a function of so controlling the spectrum conversion section 51 as to convert a spectrum distribution of incident light into a spectrum distribution approximate to the ambient light to output the same, based on a type of the external light L and the detection result (the detection signal Csens2) in the photosensor section 9.

With this configuration, the display system 2C uses, together with the source light, the external light (the light L2), which has been adjusted based on the spectrum distribution of the external light and that of the ambient light, as backlight. In the following, one embodiment will be described where the morning sunlight is used as the external light L of the display system C, and where the portions of the display system 2C, except for the light condensing section 7, are disposed in a room in which a warm color-based electric bulb is used as an illumination. Herein, the control section 55C determines that, since components such as an ultraviolet-ray component and a blue component of the external light (the light L1) are strong, a color temperature thereof is high. Also, the control section 55C determines that, since a red component of the ambient light around the display system 2C is strong, a color temperature thereof is low. Then, the control section 55C so controls the spectrum conversion section 51 as to approximate the color temperature of the external light (the light L1) to the color temperature of the ambient light. More specifically, the control section 55C so controls the spectrum conversion section 51 as to convert a spectrum, by converting a part of such as the ultraviolet-ray component and the blue component into a red component, or by weakening only such as the ultraviolet-ray component and the blue component, in the spectrum distribution of the external light (the light L1), for example. Then, the external-light control section 50C supplies the light L2 subjected to the spectrum conversion to the backlight 20. Thus, the display system 2C uses the light having the spectrum distribution which is approximate to that of the ambient light for backlight, making it possible to perform the adjustment of the white balance.

### [Modification 2-2]

In one embodiment described above, the spectrum conversion section 51 performs the spectrum conversion to adjust the spectrum distribution of backlight, although it is not limited thereto. Alternatively, a light source may be used to perform the adjustment of the spectrum distribution of backlight, one embodiment (modification 2-2) of which will be described hereinafter in detail.

A display system 2D according to this modification has a configuration in which, in the display system 1 according to the first embodiment (FIG. 1), the backlight 20 is replaced by a backlight 20D according to this modification.

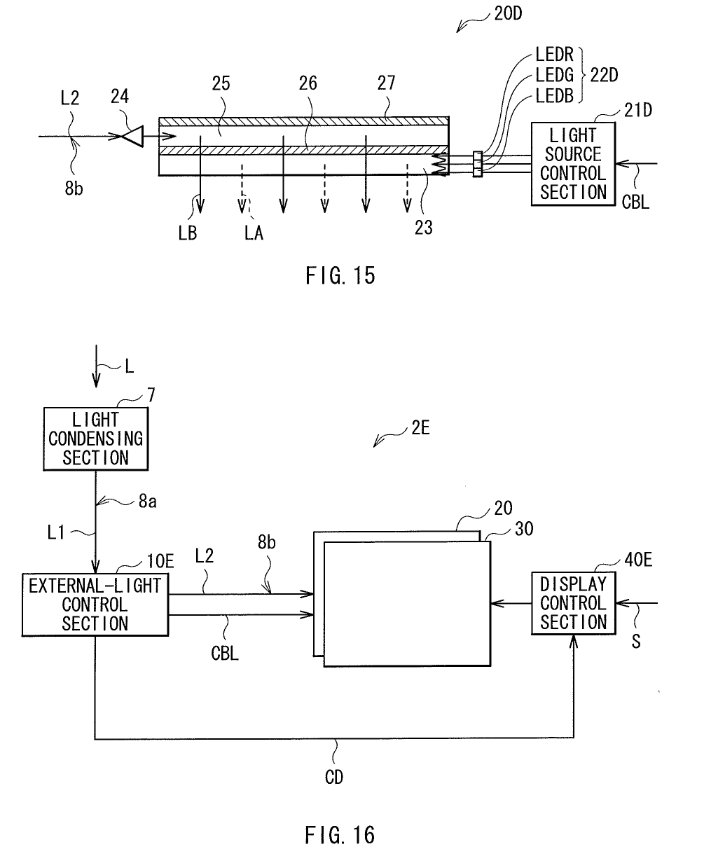

FIG. 15 illustrates an example of a configuration of the backlight 20D. The backlight 20D has a light source 22D and a light source control section 21D. The light source 22D may be configured by three LED light sources (for example, a red light source LEDR, a green light source LEDG, and a blue light source LEDB). The light source control section 21D controls, based on the backlight control signal CBL supplied from the external-light control section 10, light emission in each of the three-color LED light sources in the light source 22D, independently. It is to be noted that each of the light sources is not limited to the LEDs, and anything may be employed as long as light beams of red, green, and blue can be emitted independently. Also, the light source is not limited to a combination of the red, the green, and the blue light sources, and other colors may be employed therefore. Further, the light source is not limited to three colors. Alternatively, the light source may have two colors or less, or may have four colors or more, for example.

With this configuration, in the display system 2D, the light source control section 21D controls the light emission in each of the three-color LED light sources of the light source 22D independently, thereby making it possible to adjust the spectrum distribution of the source light of the light source 22D. Thus, even when the external light is not the white light, the spectrum distribution of the source light of the light source 22D is so adjusted as to approximate backlight to the spectrum distribution which is approximate to the more ideal white light. Hence, it is possible to adjust the white balance, and to increase image quality.

### [Modification 2-3]

In one embodiment described above, the spectrum conversion section 51 performs the spectrum conversion to adjust the spectrum distribution of backlight, although it is not limited thereto. Alternatively, displaying of the liquid crystal display section 30 may be adjusted to perform adjustment of a spectrum distribution of light exited from the backlight 20 through the liquid crystal display section 30, one embodiment (modification 2-3) of which will be described hereinafter in detail.

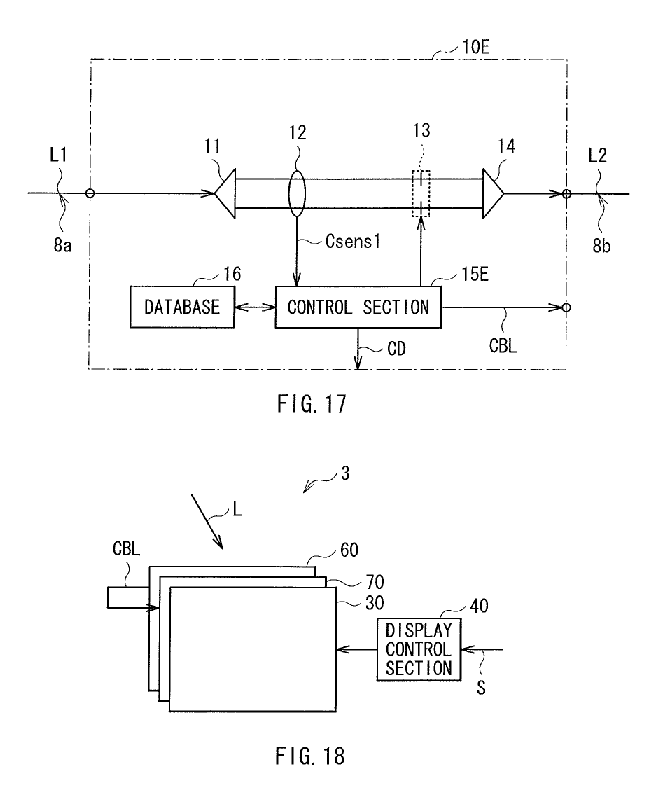

FIG. 16 illustrates an example of a configuration of a display system 2E according to the present modification. The display system 2E has an external-light control section 10E and a display control section 40E. FIG. 17 illustrates an example of a configuration of the external-light control section 10E. The external-light control section 10E has a control section 15E. The control section 15E controls, based on an identified type of the external light L, the display control section 40E using a display control signal CD. The display control section 40E controls displaying of each of a red pixel, a green pixel, and a blue pixel in the liquid crystal display section 30 independently.

With this configuration, in the display system 2E, the external-light control section 10E and the display control section 40E control, based on the identified type of the external light L, the displaying of each of the red pixel, the green pixel, and the blue pixel in the liquid crystal display section 30 independently, thereby making it possible to adjust the spectrum distribution of the light exited from the backlight 20 through the liquid crystal display section 30. Thus, even when the external light is not the white light, the white balance can be so adjusted as to display the more ideal white light when the liquid crystal display section 30 displays the white color, for example. Hence, it is possible to increase image quality.

### [Other Modifications]

Two or more of the modifications 2-1 to 2-3 described above may be combined with each other, and all such embodiments are encompassed herein.

### 3. Third Embodiment

Next, a display system 3 according to a third embodiment of the technology will be described. In the third embodiment, the external light L is directly supplied from a back face of the display system 3. Note that the same or equivalent elements as those of the display system 1 according to the first embodiment described above are denoted with the same reference numerals, and will not be described in detail.

FIG. 18 illustrates an example of a configuration of the display system 3. The display system 3 has an external-light control section 60 and a backlight 70. As in the external-light control section 10 according to the first embodiment described above, the external-light control section 60 detects the spectrum distribution of the external light L, and adjusts, based on the detection result thereof, the light intensity and the light intensity of the source light exited by the light source 22 of the backlight 70. The backlight 70, as in the backlight 20 according to the first embodiment described above, supplies the source light and the external light that is supplied from the external-light control section 60 to the liquid crystal display section 30. In the display system 3, the external light L is incident from a rear face of the external-light control section 60, and is supplied to the liquid crystal display section 30 via the backlight 70. In one embodiment, the display system 3 may be disposed at the window, and may be so disposed that the back face thereof is brought close to the window, for example. In an alternative embodiment, the display system 3 may be directly disposed at the window.

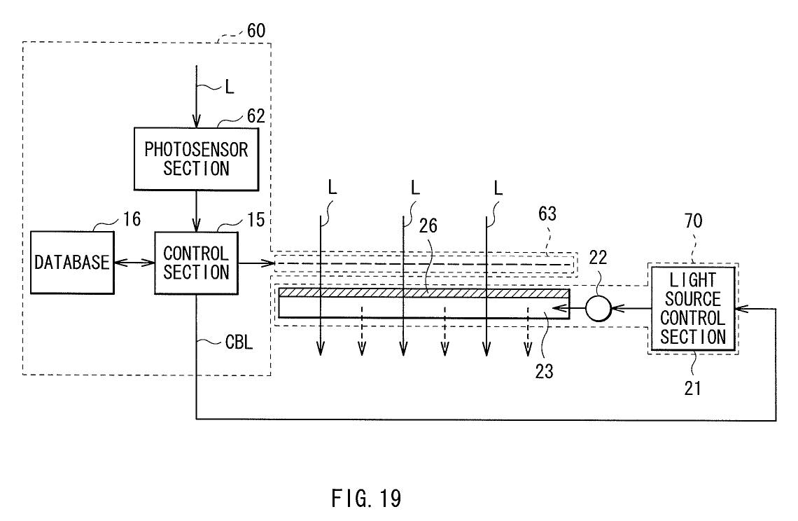

FIG. 19 illustrates examples of configurations of the external-light control section 60 and the backlight 70.

The external-light control section 60 has a photosensor section 62 and a light-intensity adjustment section 63. The photosensor section 62, as in the photosensor section 12 according to the first embodiment described above, detects the light intensity and the spectrum distribution of the external light L. The light-intensity adjustment section 63 adjusts, based on instructions from the control section 15, the light intensity of the external light L that has entered a plane corresponding to a display screen of the liquid crystal display section 30, and supplies the adjusted light to the backlight 70 within that plane.

The backlight 70 has the light source control section 21, the light source 22, the light guide plate 23, and the half mirror 26, and has the same configuration and functions as those of the corresponding portions of the backlight 20 according to the first embodiment.

According to the third embodiment, the external light is directly supplied from the rear face, thus making it possible to achieve a simple configuration. Other advantageous results are similar to those of the first embodiment described above.

### [Modification 3]

In one embodiment described above, the light-intensity adjustment section 63 is used to adjust the light intensity of the external light, although it is not limited thereto. As in the second embodiment and the modifications thereof, sections such as the spectrum conversion section may be provided to convert a spectrum. Also, the photosensor section which detects the light (the ambient light) around the display system may be further provided, to thereby perform the spectrum conversion based on the spectrum distribution of the external light and that of the ambient light.

Although the technology has been described in the foregoing by way of example with reference to some of the embodiments and the modifications, the technology is not limited thereto but may be modified in a wide variety of ways.

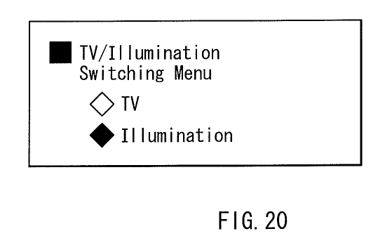

In each of the embodiments and the modifications described above, the display system displays an image, although it is not limited thereto. In one embodiment, the display system may be so configured as to be used as an illumination as well which allows the external light L to exit therefrom. FIG. 20 illustrates an example of a user interface for switching operation modes of the display system. In this user interface, the display system enters an image display mode when a user selects “TV”, whereas the display system enters an illumination mode when a user selects “Illumination”. In the illumination mode, the liquid crystal display section 30 ceases displaying of an image signal, and stays in a transparent state in which the liquid crystal display section 30 allows backlight (for example, the external light (the light LA) and the source light (the light LB)) to pass therethrough. In one embodiment, in this illumination mode, a light intensity ratio between the external light and the source light may be adjusted by a user, for example. Also, in the illumination mode, the light source may stop emission of light, and only the external light supplied from the external-light control section may be used as backlight. In particular, when the external light L is the sunlight and the display system is located in a room, it is possible to guide natural light into the room.

Also, in each of the embodiments and the modifications described above, the display system is applied to the television image receiver, although it is not limited thereto. For example, the display system may be applied to a wide variety of display devices such as, but not limited to, a cellular phone, a game device, a computer display, a mobile display, and a projector.

It should be understood by those skilled in the art that various modifications, combinations, sub-combinations and alterations may occur depending on design requirements and other factors insofar as they are within the scope of the appended claims or the equivalents thereof.

What is claimed is:

1. A display system, comprising:
a liquid crystal display section displaying an image;
a backlight source emitting source light;
a photosensor section detecting a spectrum distribution of external light supplied from outside; and
an external-light adjustment section adjusting the external light based on a detection result of the photosensor section,
wherein the backlight source supplies the emitted source light to the liquid crystal display section, and
the external-light adjustment section supplies the adjusted external light to the liquid crystal display section.

2. The display system according to claim 1, wherein the external-light adjustment section adjusts a light intensity of the external light to be reduced when the spectrum distribution of the external light is out of a predetermined range.

3. The display system according to claim 1, wherein the external-light adjustment section performs a spectrum conversion of the spectrum distribution of the external light into a spectrum distribution which is more approximate to white.

4. The display system according to claim 3, wherein the external-light adjustment section performs the spectrum conversion when the spectrum distribution of the external light is within a predetermined range.

5. The display system according to claim 1, further comprising a light source control section controlling the backlight source based on the detection result of the photosensor section.

6. The display system according to claim 5,
wherein the backlight source includes a red-light source, a green-light source, and a blue-light source, and
the light source control section controls a light intensity of each of the red-light source, the green-light source, and the blue-light source independently, based on the detection result of the photosensor section.

7. The display system according to claim 5,
wherein the photosensor section detects a light intensity of the external light, and
the light source control section controls the light intensity of the source light to be higher when the light intensity of the external light is lower than a predetermined light intensity.

8. The display system according to claim 1, further comprising a display control section controlling the liquid crystal display section,
wherein the liquid crystal display section includes a red pixel, a green pixel, and a blue pixel, and
the display control section controls pixel displaying of each of the red pixel, the green pixel, and the blue pixel independently, based on the detection result of the photosensor section.

9. The display system according to claim 1,
wherein the photosensor section detects a light intensity of the external light, and
the external-light adjustment section adjusts the light intensity of the external light to be reduced when the light intensity of the external light is higher than a predetermined light intensity.

10. The display system according to claim 1, further comprising a light condensing section condensing the light,
wherein the external light is supplied from the light condensing section via an optical fiber.

11. The display system according to claim 1, wherein the external light is directly supplied from a back face of the liquid crystal display section.

12. The display system according to claim 1, wherein the external light is sunlight.

13. The display system according to claim 1, further comprising a plurality of operation modes including an image display mode and an illumination mode,
wherein the liquid crystal display section displays the image in the image display mode, and
the liquid crystal display section stays in a transparent state in the illumination mode.

14. The display system according to claim 1, wherein the liquid crystal display section displays a ratio of the light intensity between the source light and the external light which are supplied to the liquid crystal display section.

15. The display system according to claim 1, further comprising an ambient light sensor section detecting light around the display system.

16. The display system according to claim 1, wherein the backlight includes a half mirror allowing light incident on a first face thereof to exit from a second face thereof, and allowing light incident from the second face to be reflected.

17. The display system according to claim 2, wherein the predetermined range is preselected by a user.

18. The display system according to claim 12, further comprising an ambient light sensor section detecting light around the display system.

19. A backlight system, comprising:
a backlight source emitting source light;
a photosensor section detecting a spectrum distribution of external light supplied from outside; and
an external-light adjustment section adjusting the external light based on a detection result of the photosensor section,
wherein the backlight source supplies the emitted source light to a liquid crystal display section, and
the external-light adjustment section supplies the adjusted external light to the liquid crystal display section.
